(19) United States
(12) Patent Application Publication
(10) Pub. No.: US 2002/0135926 A1
(43) Pub. Date: Sep. 26, 2002

(54) Methods and device for automated static attitude and position measurement and static attitude adjust of head suspension assemblies

(76) Inventors: Mark T. Girard, Hutchinson, MN (US); Joseph P. Tracy, Hutchinson, MN (US); David R. Swift, Hutchinson, MN (US); Ryan A. Jurgenson, Hutchinson, MN (US)

Correspondence Address: MARK W. BINDER, KAGAN BINDER PLLC, 221 MAIN STREET NORTH, SUITE 200, MAPLE ISLAND BUILDING, STILLWATER, MN, 55082, US

(21) Appl. No.: 09/938,321

(22) Filed: Aug. 23, 2001

Related U.S. Application Data
(60) Provisional application No. 60/227,480, filed on Aug. 24, 2000.

(51) Int. Cl. G11B 21/02

(52) U.S. Cl. 360/75

(57) ABSTRACT

The present invention provides apparatus for measurement of suspension assembly component position and static attitude and for adjustment thereof. An apparatus in accord with the present invention includes modules for the measurment and adjustment of the gimbal portion of suspensions, FSAs, and HGAs.

### BACKGROUND OF THE INVENTION

Most personal computers today utilize direct access storage devices (DASD) or rigid disk drives for data storage and retrieval. Present disk drives include a disk rotated at high speeds and a read/write head that, in industry parlance, “flies” a microscopic distance above the disk surface. The disk includes a magnetic coating that is selectively magnetizable. As the head flies over the disk, it “writes” information, that is, data, to the hard disk drive by selectively magnetizing small areas of the disk; in turn, the head “reads” the data written to the disk by sensing the previously written selective magnetizations. The read/write head is affixed to the drive by a suspension assembly and electrically connected to the drive electronics by an electrical interconnect. This structure (suspension, electrical interconnect, and read/write head) is commonly referred to in the industry as a Head Gimbal Assembly, or HGA.

More specifically, currently manufactured and sold read/write heads include an inductive write head and a magnetoresistive (MR) read head or element or a “giant” magnetoresistive (GMR) element to read data that is stored on the magnetic media of the disk. The write head writes data to the disk by converting an electric signal into a magnetic field and then applying the magnetic field to the disk to magnetize it. The MR read head reads the data on the disk as it flies above it by sensing the changes in the magnetization of the disk as changes in the voltage or current of a current passing through the MR head. This fluctuating voltage in turn is converted into data. The read/write head, along with a slider, is disposed at the distal end of an electrical interconnect/suspension assembly.

An exploded view of a typical electrical interconnect/suspension assembly is shown in FIG. 1, which illustrates several components including a suspension A and an interconnect B. It will be understood that the actual physical structures of these components may vary in configuration depending upon the particular disk drive manufacturer and that the assembly shown in FIG. 1 is meant to be illustrative of the prior art only. Typically, the suspension A will include a base plate C, a radius (spring region) D, a load beam E, and a flexure F. At least one tooling discontinuity 57 G may be included. An interconnect B may include a base H, which may be a synthetic material such as a polyimide, that supports typically a plurality of electrical traces or leads I of the interconnect. The electrical interconnect B may also include a polymeric cover layer that encapsulates selected areas of the electrical traces or leads I.

Stated otherwise, suspension A is essentially a stainless steel support structure that is secured to an armature in the disk drive. The read/write head is attached to the tip of the suspension A with adhesive or some other means. The aforementioned electrical interconnect is terminated to bond pads on the read/write head and forms an electrical path between the drive electronics and the read and write elements in the read/write head. The electrical interconnect is typically comprised of individual electrical conductors supported by an insulating layer of polyimide and typically covered by a cover layer.

As mentioned previously, the slider “flies” only a microscopic distance, or fly height, above the spinning media disk. Control of fly height is critical for the operation of a disk drive. If the fly height is too large, the read/write head will not be able to read or write data, and if it is to small, the slider can hit the media surface, or crash, resulting the permanent loss of stored data. As such, the fly height of the slider is determined in much part by the characteristics of the head suspension assembly to which it is mounted. The head suspension imparts a vertical load, commonly referred to as “gram load”, on the slider, normal to the surface of the disk, in order to oppose the “lift” forces created by the air passing between the slider and the spinning disk. As a result, head suspension assemblies are manufactured with a very precise gram load, typically with a tolerance of ±0.2 grams. Another head suspension assembly characteristic that has a significant effect upon the fly height of a slider, is referred to as “static attitude”. Static attitude is the angular attitude of the gimbal to which the slider is mounted. Typically, head suspension assemblies are manufactured with tolerances for static attitude approaching ±30 arc-minutes.

Successful reading or writing of data between the head and the spinning media also requires that the head be precisely positioned directly under the suspension load point location, such that the act of passing the commonly known preload from suspension to head does not cause the head slider body to pitch or roll.

Due to manufacturing difficulties within suspension, flex circuit attach (FSA) and head gimbal assembly (HGA) processes, there is a need to inexpensively perform 100% measure and adjustment for static attitude, as well as 100% measurement for component assembled position.

Common industry equipment for measuring static attitude requires that individual suspensions, FSAs, or HGAs be loaded into a tooling fixture with said tooling fixture precisely aligning the component to an autocollimator beam while bending the component to its designed working z position. This measurement takes a considerable amount of time and requires significant operator handling and requires that the loading mechanism consistently deform the component without damaging said component. Further complications include small X-Y positional misalignments between the autocollimator beam and the component to be measured, which said misalignments can lead to erroneous measurements. A still further complication with common autocollimator based static attitude measurements lies with the fact that the autocollimator beam is masked very close to the measured component. The mask serves to only allow a certain desired location to be measured on the component. This masking technique can interfere with other mechanisms desired to operate in and around the component, blocks a portion of the light trying to return to the autocollimator, and obstructs the visual view of the component.

While it is also desired to make X-Y and theta measurements of components assembled which make up suspensions, FSAs, and HGAs; said position measurements take extra time and capital thus adding significant cost to a given process.

While numerous mechanisms exist to mechanically and thermally adjust suspensions, FSAs, and HGAs for static attitude, several limitations exist. A first limitation exists with those methods which act on the load beam, since adjustment to the load beam will cause an undesired shift in load beam dominant resonant frequencies and gains. To avoid the previously mentioned limitation, many have sought to perform adjustments only on the gimbal portion of suspensions, FSAs, and HGAs, but these methods are limited due to misalignment of the adjust mechanisms relative to the components being adjusted. It is very difficult to have precise control over the said static attitude angles of said suspensions, FSAs, and HGAs, when the component geometries are very small, very thin, and fragile.

### SUMMARY OF THE INVENTION

It is an object of the present invention to provide a device which can simultaneously measure component position and static attitude and can precisely adjust said static attitude in the gimbal portion of suspensions, FSAs, and HGAs.

A further objective of the present invention is to hold the components fixed via an optimum vacuum, or other non-deforming means, such that complicated fixturing and deformation prior to measurement is not needed.

Another object of the present invention is to assure precise autocollimator spot location on the component by directing the spot with vision, including co-located vision feedback.

A still further objective of the present invention is to use the same vision system to simultaneously extract position information for quality control of component assembly.

Another object of the present invention is to use the said co-located vision feedback for precisely positioning static attitude adjust mechanisms relative to the gimbal component to significantly improve control over said adjust processes.

A further objective is to control vision lighting to allow for proper vision system function, while not interfering with the autocollimator return light and not adversely affecting the said static attitude measurements.

A still further objective is to locate a mask between the autocollimator light source and the autocollimator optics to adequately size the spot on the desired component location, without causing interference with other mechanisms or clipping return light.

### BRIEF DESCRIPTION OF THE DRAWINGS

FIG. 1 illustrates a typical electrical interconnect/suspension assembly.

FIG. 2 illustrates a hard disk drive in a top plan, schematic view.

FIG. 3a illustrates an actuator arm in a side elevation view.

FIG. 3b illustrates in greater detail in a top plan view the hatched area called out in FIG. 3a.

FIG. 4 illustrates an interconnect assembly in a top plan view.

FIG. 5 illustrates the interconnect assembly of FIG. 4 in an exploded perspective view.

FIG. 6 illustrates an apparatus in accord with the present invention in a front elevation view.

FIGS. 7A and 7B illustrates measurement and adjustment modules in accord with the present invention.

FIG. 8 illustrates a static measurement probe in accord with the present invention.

FIGS. 9A-9C illustrate in further detail a static measurement probe in accord with the present invention.

FIG. 10 illustrates optics utilized to collocate the vision field of view and measurement beam from the static attitude measurement probe

FIG. 11 illustrates the adjustment module in greater detail in a side elevation view.

FIG. 12 illustrates one example of the relative location of the stationary top clamp and the moving top clamp of the adjustment module.

FIG. 13 illustrates the clamps of FIG. 12 in a side elevation, cross-sectional view.

FIG. 14 illustrates a method for adjusting static attitude as described herein.

### DETAILED DESCRIPTION OF THE INVENTION

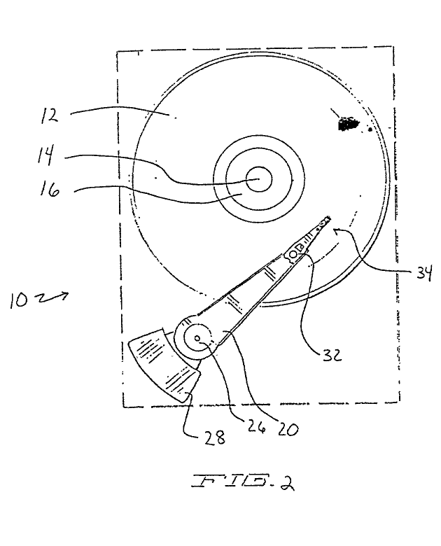

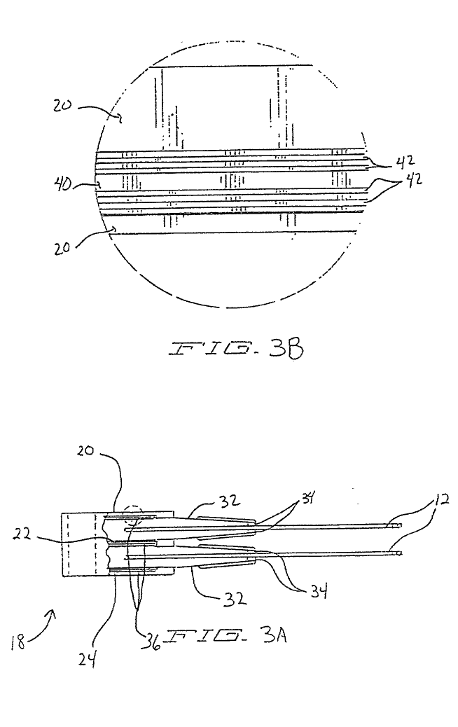

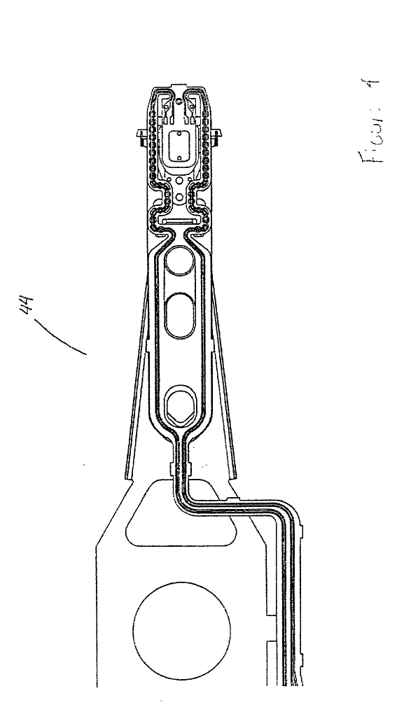

FIGS. 2, 3A, and 3B illustrate a hard disk drive 10 in a top plan, highly schematic view. It will be understood that many of the components found in such a disk drive 10, such as memory cache and the various controllers are not shown in the figure for purposes of clarity. As illustrated, drive 10 includes at least one, and typically several, disks 12 mounted for rotation on a spindle 14, the spindle motor and bearing not being shown for purposes of clarity. A disk clamp 16 is used to position and retain the disk 12 on the spindle 14. The disk drive 10 further includes an “E” block 18, best seen in FIG. 2. The E block 18 gets its name from its shape as viewed from the side. It will be observed that E block 18 includes a plurality of actuator arms 20, 22, and 24, which are supported for pivotal motion by an actuator pivot bearing 26. A voice coil motor assembly 28 is used to control the pivoting motion of the actuator arms 20-24.

Each actuator arm 20-24 includes a head gimbal assembly 30 comprising a suspension 32, a read/write head/slider 34, and interconnect 36 that extends from the head/slider to the actuator flex 38. The dashed circle shows an expanded view of the arm 20, which includes a substrate 40 (wherein the bracket indicates the lateral extend of the substrate relative to the actuator arm 20 in this particular embodiment) upon which electrical leads or traces 42 are supported. The electrical conductors 42 are typically copper or copper alloy with a gold plating.

The substrate 40 will substantially underlie the traces 42. Substrate 40 may comprise a synthetic material such as polyimide, which may be of the type sold under the brand name Kapton by I. E. DuPont.

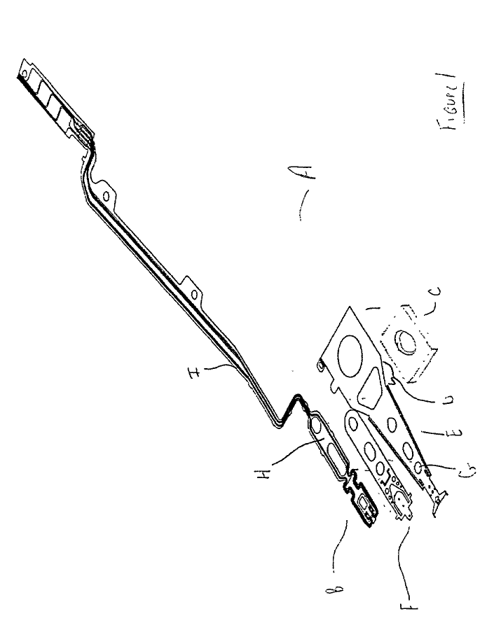

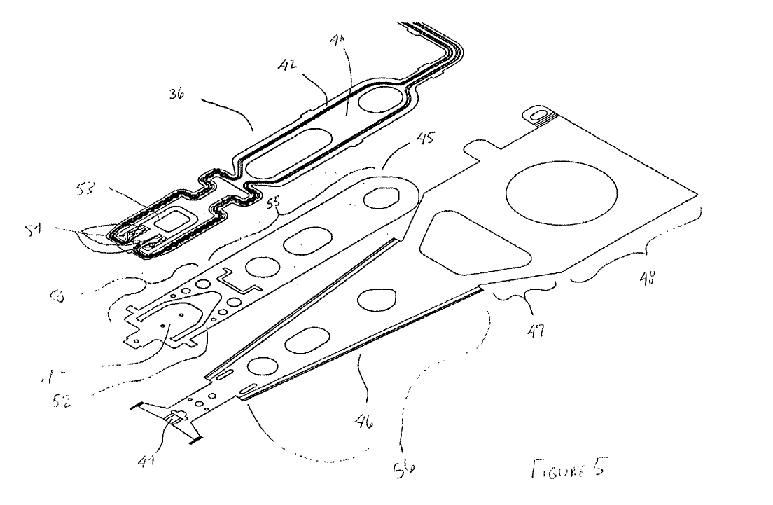

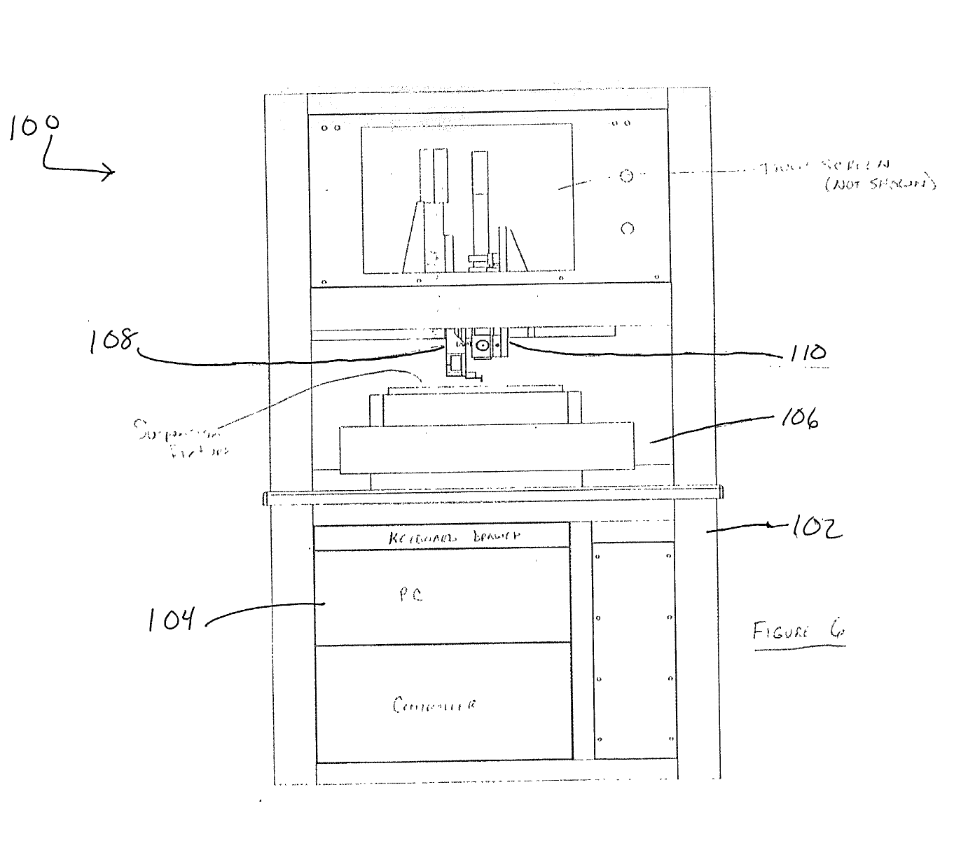

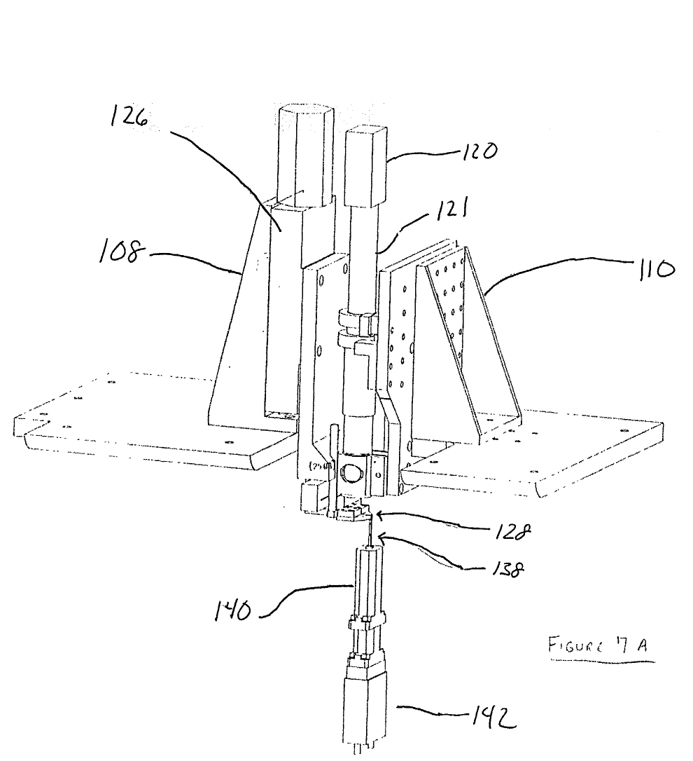

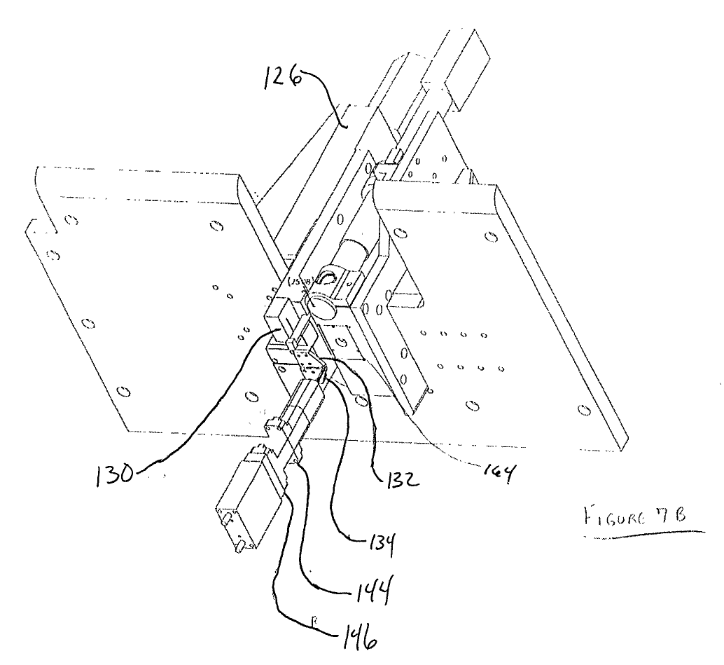

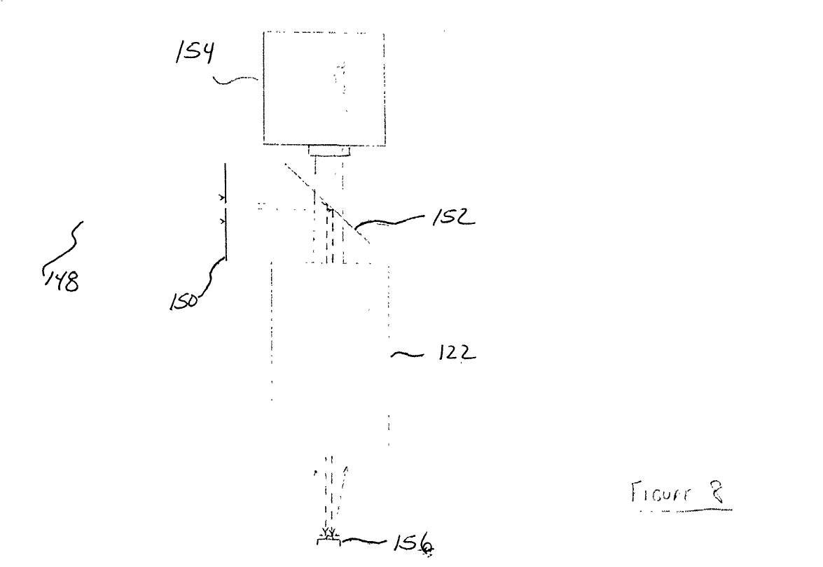

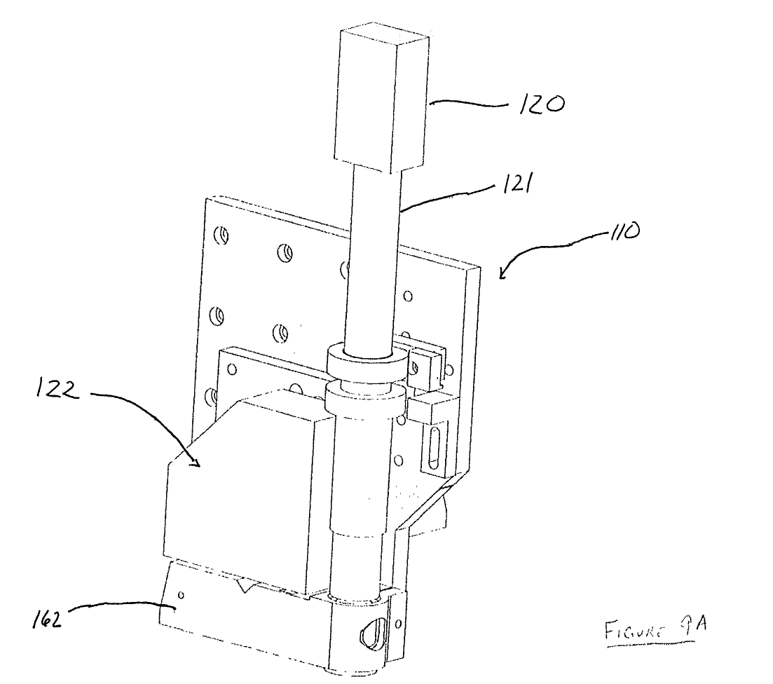

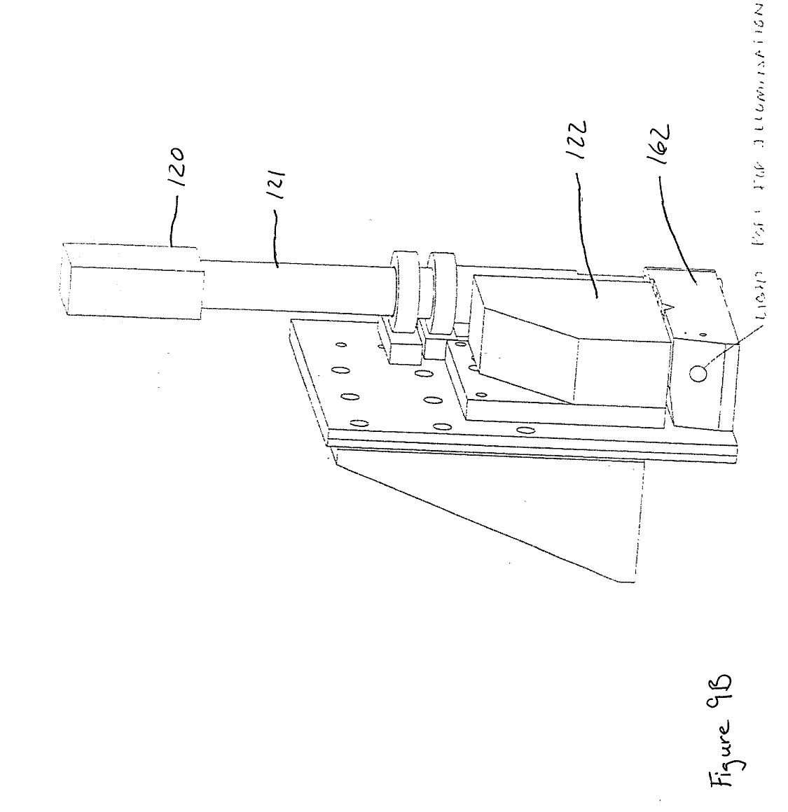

FIGS. 4 and 5 illustrate an example of a head suspension/electrical interconnect assembly 44 for which the present invention is intended. Assembly 44, like that shown in FIG. 1, may have varying configurations depending upon the manufacturer. Assembly 44 is comprised of four primary components; loadbeam 46, flexure 45, electrical interconnect 36, and baseplate (not shown for the purposes of clarity). The loadbeam 46 can be properly described as having a mounting region 48 (to which a baseplate is mounted), a spring region 47, a load beam body 56, and a loadpoint 49. Similarly, the flexure 45 is comprised of a flexure body 55 and a gimbal region 50. The flexure body 55 is rigidly affixed to the load beam body 56, typically with one or more spot welds. As such, the gimbal region 50 of the flexure 45 is not rigidly affixed to the loadbeam 46. Within the gimbal region 50 of the flexure 45, there is a support pad, commonly referred to as the tongue 51. The tongue 51 is in point contact with the loadpoint 49, and provides for a mounting surface to which the slider is affixed with adhesive or some other means. The tongue 51 is connected to the flexure body 55 by resilient springs, commonly referred to as flexure or gimbal arms 52. This construction of flexure 45 and load beam 46 provides for the tongue 51 to pivot, or gimbal, about the loadpoint 49 when a small torque is applied. The flexure 45 and load beam 46 assembly is referred to as a “conventional” suspension assembly. After the electrical interconnect 36 has been applied to a conventional suspension assembly, the assembly will more properly be referred to as a head suspension/electrical interconnect assembly 44.

The electrical interconnect 36, as described previously, generally consists of a base substrate 40, such as polyimide, supporting electrical leads or traces 42. At one end of the electrical interconnect 36 are slider termination pads 54 which form electrical connections to the read/write head. The electrical interconnect 36 may also have an area of substrate that is sandwiched between the flexure tongue 51 and the read/write head slider. The electrical interconnect 36 is attached to the conventional suspension assembly such that is rigidly affixed to the suspension assembly in areas proximal to the flexure body 55 and load beam body 56. The electrical interconnect 36 may also be rigidly attached to the flexure tongue 51.

It is desirable to attach the electrical interconnect 36 to the conventional head suspension assembly as described previously, without significantly impacting the performance of the conventional head suspension assembly. Specifically, while adhesive is needed to affix the electrical interconnect 36 to both the load beam body 46/flexure body 55 and flexure tongue 51, adhesive in the flexure arm 52 region of the conventional assembly can cause significant performance issues. Adhesive in the flexure arm 52 region can cause changes to the static angle of the tongue 51 resting on the loadpoint 49, as well as increases to the rotational stiffness of the gimbal region 50. Additionally, due to the wicking nature of the adhesive used to attach the electrical interconnect 36 to the conventional head suspension, an adhesive bond is formed not only at the interface between the adjacent surfaces of the electrical interconnect 36 and the conventional head suspension assembly, but also between the adjacent surfaces of the flexure 45 and the load beam 46. The adhesive bonds resulting from the attachment of the electrical interconnect 36 to the conventional head suspension assembly can significantly affect the resulting bending stiffness of the head suspension/electrical interconnect 44, thereby changing it's dynamic resonant characteristics. As such, it is desired that the adhesive bond characteristics are repeatable from one assembly to the next.

Referring now to FIGS. 6-14, the present invention will be described in broad detail. FIG. 6 illustrates one embodiment 100 of a device in accord with the current invention. The static attitude measurement and adjustment machine shown here includes a frame 102, computer 104 indicated generally, and related input/output devices such as a touch screen to operate such devices, and an X and Y motion axis and controller 106. Apparatus 104 further includes an adjustment module 108 and a static attitude measurement module 110.

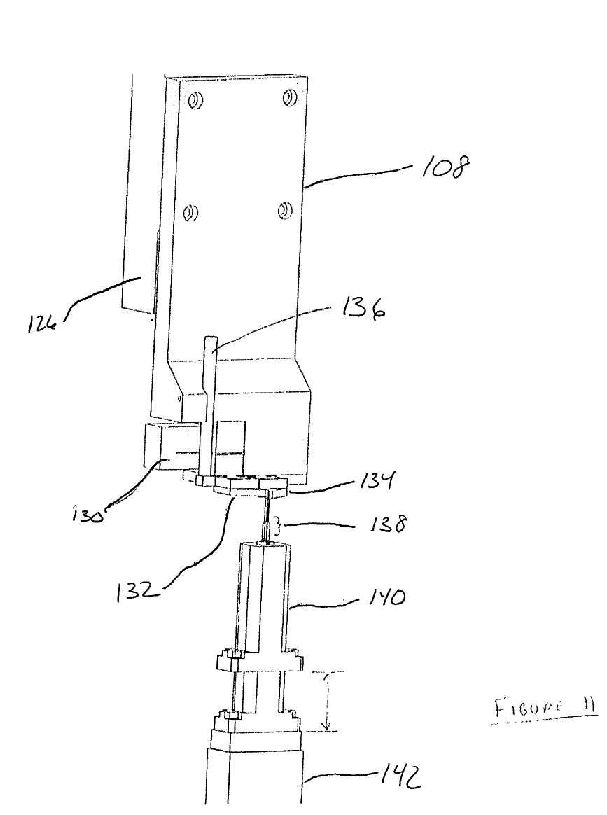

FIGS. 7A and 7B provide a more detailed view of the adjustment and static attitude measurement modules 108 and 110, respectively. The static attitude measure module 110 includes a camera 120 and vision optics 121 that are used to optically locate the suspension assemblies, a static attitude measurement probe or auto-collimator 122 (FIG. 8) to measure the relative angular attitude of surfaces of interest, and an optics assembly 124 (FIG. 10) that collocates the laser beam from the measurement probe and the field of view of the vision optics.

The adjust module 108 generally contains a Z actuator 126 which positions the top clamps 128 in close proximity to the suspension to be adjusted, a piezo actuator 130 which precisely positions the moving top clamp 132 relative to the stationary top clamp 134, and an LVDT 136 which provides position feedback for control of the piezo actuator 130. The bottom clamps 138 are spring loaded and guided by the bottom clamp spring housing 140, and actuated in the Z direction to engage with the top clamps 128 by the bottom clamp actuator 142, which as shown here is a pneumatic cylinder. FIG. 7B shows the actuator 142 in extended and retracted positions 144 and 146, respectively.

FIG. 8 details the fundamental design of the static attitude measurement probe 110 in accord with the present invention. As mentioned earlier, typical auto-collimator measurement devices require that the laser beam be masked with an aperture in close proximity to the surface being measured. In this case, a laser 148 produces a laser beam that is masked with an aperture 150 prior to the beam entering the optical path of the autocollimator, thereby eliminating the need for a mask near the surface being measured. Additionally, the mask, or aperture, 150 can be moved small amounts to adjust the laser spot location at the surface of the object being measured. FIG. 8 also illustrates a beam splitter 152 and a charged couple device array 154 used for imaging the suspension gimbal 156.

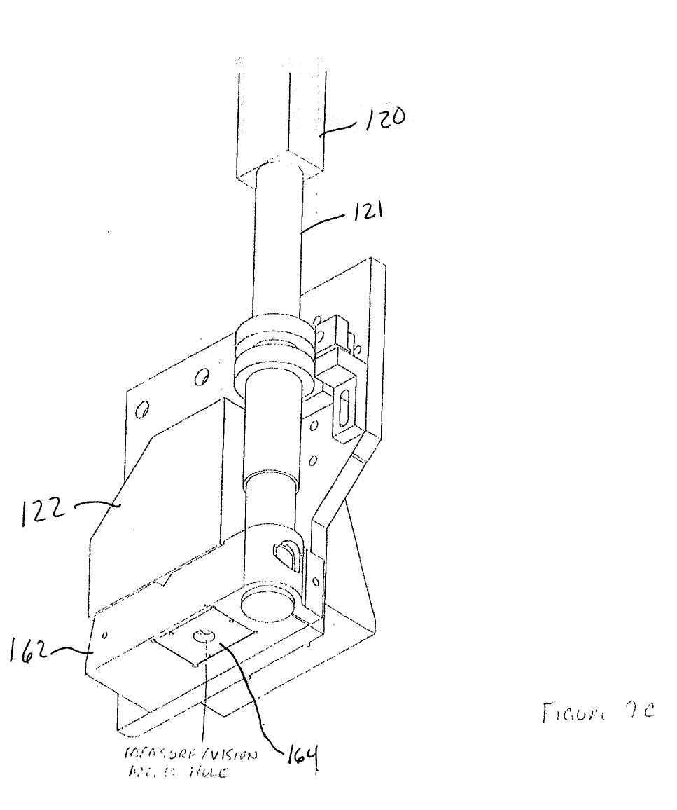

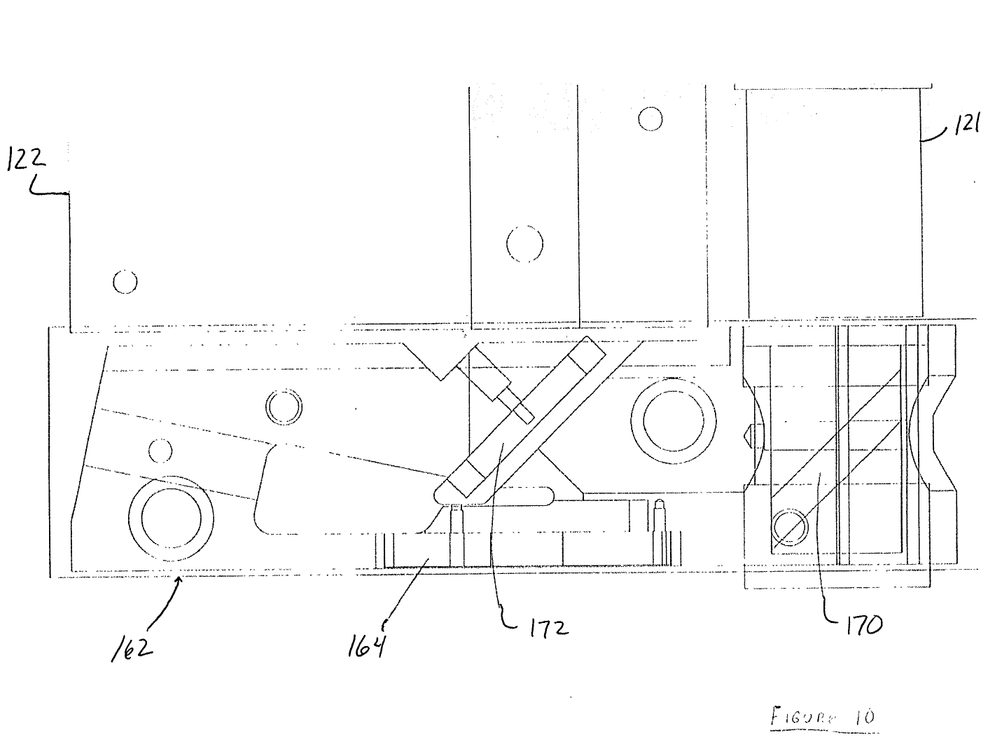

FIGS. 9A-9C provides more illustration of the static attitude measurement module 110, specifically. As mentioned earlier, the static attitude measurement module includes a static attitude measurement probe 122, a camera and vision optics 120, and an optical assembly 160 disposed within an optical housing 162 which combines the field of view of the vision system and the measurement laser beam at the same location. A diffuser 164 and light source provide for necessary diffuse illumination of the suspension or HGA. The opal diffuser 164 has an aperture in line with the optical path of the measurement probe and vision system, so as not to obstruct either. The light source is shuttered so that no light is present while the static attitude measurement probe 122 is capturing a measurement.

FIG. 10 provides more detail with respect to the optical assembly utilized to collocate the vision field of view and measurement beam from the static attitude measurement probe. A 45 degree mirror 170 and pellicle beamsplitter 172 are used to bring the vision field of view in-line with the laser beam from the measurement probe. The laser beam from the measurement probe passes directly through the pellicle beam splitter 172, but the reflected image from the pellicle beamsplitter is used for vision purposes. As mentioned earlier, vision can be used to determine the relative location of the suspension or HGA, allowing for precise positioning of the measurement beam and adjust tooling on the suspension or HGA.

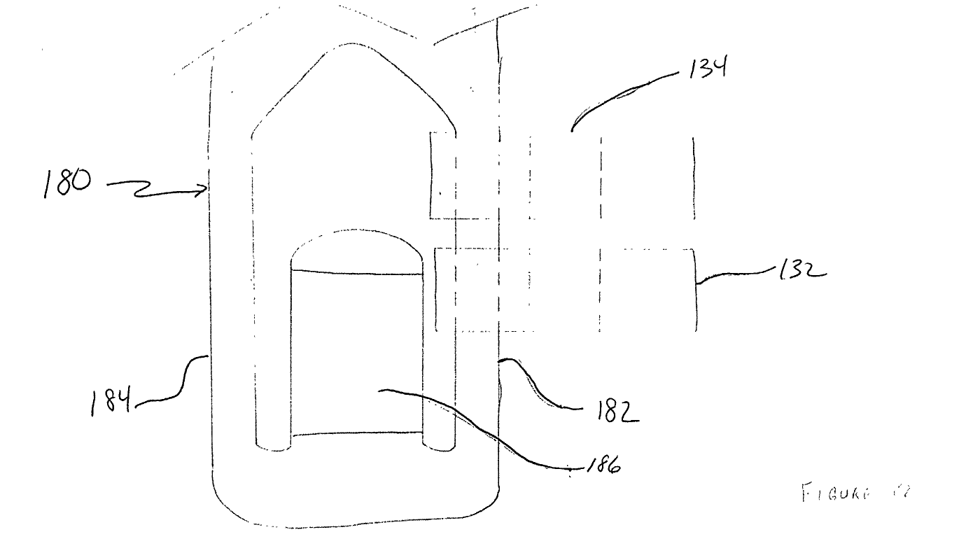

FIG. 11 provides additional information about the static attitude adjust module 108. The adjust module includes a Z-actuator 126 which positions the moving and stationary top clamps 132 and 134 in close proximity to the suspension to be adjusted. The piezo actuator 126 precisely positions the moving top clamp 132 relative to the stationary top clamp 134 utilizing feedback from the LVDT 136. The bottom clamps 138 then engage with the top clamps 128 when the bottom clamp actuator 142 is extended.

In some cases it is beneficial to do a two stage adjustment on each gimbal arm, wherein the gimbal arm is first bent a large amount in one direction and then adjusted towards its target position. This is referred to as a “Pre-Bend”, and can both improve the adjustability and stability of the adjust process.

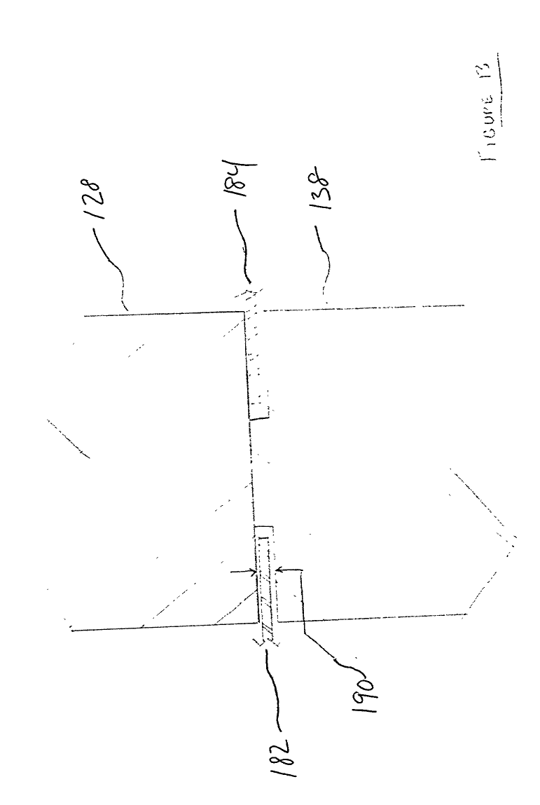

FIG. 12 illustrates one example of the relative location of the stationary top clamp 134 and the moving top clamp 132. Generally, the stationary top clamp 134 is positioned on the baseplate side of the moving top clamp 132. Also shown in the figure is a gimbal 180 including first and second gimbal arms 182 and 184 and a slider 186.

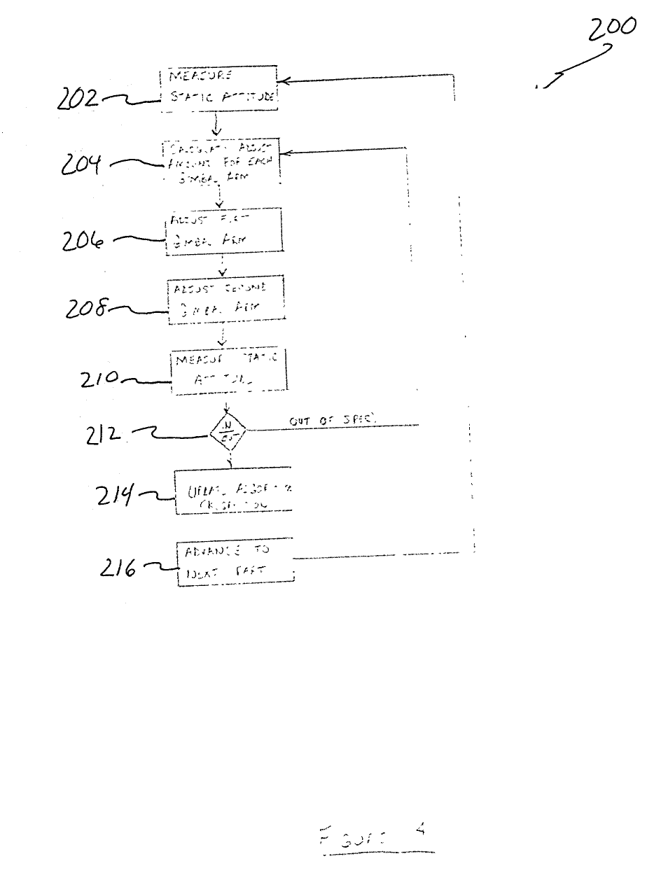

FIG. 13 is a cross-sectional view of the bottom and top clamps 138 and 128, respectively, engaged. Note that the punch clearance 190 on the bottom clamp ensures that gimbal arms 182 and 184 are not clamped. This helps ensure that the gold plating on the conductors is not damaged by the adjust tooling.

FIG. 14 illustrates a process overview 200 of the adjustment cycle. Thus, a process in accord with the present invention would include measuring the static attitude of a gimbal at 202. From the measurement, a calculation is made at 204 of the amount of adjustment necessary to each gimbal arm to provide the desired static attitude. The first and second arms are respectively adjusted then by clamping the arms and moving the clamps to provide the desired static attitude as indicated at 206 and 208 respectively. The static attitude of the adjusted suspension would then be measured again at 210. A comparison of the measurement at 210 would be made with the desired specification at 212. If the static attitude was not within specification, the process would be repeated. If the measured static attitude was within specification, the algorithm controlling the adjustment would be updated at 214 and a new part would be adjusted at 216.

The device detailed above provides for an adjustment range of ±4 degrees for both pitch and roll static attitude, and can achieve capabilities of ±0.15° (±3 standard deviations) in static attitude.

The device and method described above provides information with regards to one embodiment of the present invention, but one skilled in the art can imagine a number of variants that would still be in accord with the scope of this application.

The present invention having thus been described, other modifications, alterations, or substitutions may also now suggest themselves to those skilled in the art, all of which are within the spirit and scope of the present invention. It is therefore intended that the present invention be limited only by the scope of the attached claims below.

What is claimed is:

1. Apparatus for automated measurement and adjustment of static attitude comprising:
means for measuring static attitude of a suspension assembly, said means including means for imaging a suspension; and
means for adjusting the static attitude of a suspension assembly.

2. The apparatus of claim 1 wherein said means for adjusting comprises top and bottom clamps for gripping the suspension, said clamps being relatively movable so as to provide the desired static attitude.

3. A method for automated measurement and adjustment of static attitude comprising:
measuring the static attitude of a suspension;
calculating the static attitude of the suspension and determining the amount by which the measured static attitude varies from the desired static attitude; and
adjusting the gimbal arms of a suspension by clamping the arms and bending them a predetermined amount so as to bring the static attitude within the desired specification.
